(19) United States
(12) Patent Application Publication
(10) Pub. No.: US 2009/0167536 A1
(43) Pub. Date: Jul. 2, 2009

(54) Personal Safety System

(76) Inventors: Cecil Clark, Dorset (GB); Mark Morgan, Dorset (GB)

Correspondence Address: HAVERSTOCK & OWENS LLP, 162 N WOLFE ROAD, SUNNYVALE, CA, 94086, US

(21) Appl. No.: 11/991,679

(22) PCT Filed: Sep. 7, 2006
(86) PCT No.: PCT/GB2006/003312

§ 371 Date: Feb. 27, 2009

(30) Foreign Application Priority Data
Sep. 9, 2005 (GB) 0518434.6

(51) Int. Cl. G08B 23/00; G08B 21/00

(52) U.S. Cl. 340/573.4; 340/686.1

(57) ABSTRACT

A personal safety system is disclosed. The personal safety system comprises: a personal safety device and a base unit coupled over a local communications link; transceiver logic operable to transmit a periodic status message and an acknowledgement message generated in response to each received status message between said personal safety device and said base unit over said local communications link; and alert logic operable, in the event that said transceiver logic indicates that a number of either of said status and acknowledgement messages fail to be transmitted between said personal safety device and said base unit, to activate an alarm mechanism on both said personal safety device and said base unit. Accordingly, the member of crew wearing the personal safety device will detect the alarm mechanism activating and be provided with the assurance that a similar alarm mechanism is activating on the base unit.

### FIELD OF THE INVENTION

The present invention relates to a personal safety system.

### BACKGROUND OF THE INVENTION

Personal safety systems are known. In one type of known safety system, such as those used with vessels, a water or manually-activated individual safety beacon is typically worn by crew of the vessel. In the event that the member of the crew gets into difficulty then the individual safety beacon may be activated. Similarly, should a member of the crew fall overboard, then a water-detection mechanism will detect the presence of water and activate the individual safety beacon.

When the individual safety beacon activates, a low power transmission occurs on the maritime emergency channel (transmitted at 406), this low powered emergency transmission is subsequently detected by a satellite when transiting over the geographic region of the individual safety beacon and the position of the individual safety beacon can be determined using standard Doppler techniques. In addition, the equipment uses a supplementary low power emergency transmitter working on the aircraft distress channel (121.5 MHz) that can be detected and used by search and rescue organisations using local direction-finding apparatus.

In this way, it will be appreciated that should a member of the crew get into an emergency situation, an emergency message can be transmitted to the search and rescue organisation.

In an alternative known system, a receiver station is provided on a vessel and each member of the crew is provided with a low power man overboard transmitter. The low power man overboard transmitter periodically transmits a signal on a single frequency public transmission channel from the man overboard transmitter to the receiver station. In the event that the transmission from the man overboard transmitter to the receiver station is interrupted, for example, due to the member of the crew falling off the vessel and going out of range of the receiver station, an alarm sounds on the receiver station to alert the other members of the crew onboard.

Whilst both of these devices clearly provide enhanced safety to the crew members, they suffer from a number of drawbacks.

Accordingly, it is desired to provide an enhanced personal safety system.

### SUMMARY OF THE INVENTION

According to one aspect of the present invention there is provided a personal safety system, comprising: a personal safety device and a base unit coupled over a local communications link; transceiver logic operable to transmit a periodic status message and an acknowledgement message generated in response to each received status message between the personal safety device and the base unit over the local communications link; and alert logic operable, in the event that the transceiver logic indicates that a number of either of the status and acknowledgement messages fail to be transmitted between the personal safety device and the base unit, to activate an alarm mechanism on both the personal safety device and the base unit.

The present invention recognises that a problem with the individual safety beacon is that any crew onboard the vessel are not alerted by its operation. Also, because the emergency signal is only detected by a transiting satellite, the member of the crew may be off the vessel for a relatively long period of time prior to the emergency signal even being detected.

The present invention also recognises that a problem with the man overboard transmitter is that the one-way communication can be unreliable and a false alarm can occur without the member of the crew even being aware of this.

The present invention further recognises that for both the individual safety beacon and the man overboard transmitter, the member of crew in the emergency situation has no indication that his status has even been noted by another party.

Accordingly, the personal safety device and base unit are provided which are coupled over a local communications link. Periodic messages are transmitted between the personal safety device and the base unit. Should it be recognised that messages are no longer being transmitted between the personal safety device and the base unit, an alarm mechanism is activated both at the personal safety device and at the base unit. In this way, the member of crew wearing the personal safety device will detect the alarm mechanism activating and be provided with the assurance that a similar alarm mechanism is activating on the base unit.

In embodiments, the alarm mechanism on the personal safety device and the alarm mechanism on the base unit each comprise a timer and an alarm, each of the alarm mechanisms being operable on activation to start the timer and to activate the alarm when a time period measured by the timer expires, the time period measured by the timer of the alarm mechanism on the personal safety device being shorter than the time period measured by the timer of the alarm mechanism on the base unit.

By making the time period measured by the personal safety device less than that measured by the base station, the alarm will sound on the personal safety device prior to sounding on the base station. This allows the user to become aware that an alarm will sound shortly at the base station and, in the event of a false alarm, enable to user to take corrective action to avoid the false alarm.

In embodiments, the alert logic is operable to deactivate the alarm mechanism on the personal safety device and the alarm mechanism on the base unit in the event that the transceiver logic indicates that either of the status and acknowledgement messages are transmitted between the personal safety device and the base unit Hence, in the event that transmission recommences between the base unit and personal safety device, the alarm mechanism can be deactivated thereby further reducing the incidence of false alarms.

In embodiments, the personal safety device further comprises an emergency indication mechanism, the transceiver logic is operable, in the event that the emergency indication mechanism is activated, to cause an emergency indication message to be transmitted over the local communications link and the alert logic is operable, in the event that the transceiver logic indicates the emergency indication message has been transmitted over the local communications link, to activate the alarm mechanism.

Accordingly, should the member of crew find themselves in an emergency situation such as, for example, suffering from a medical emergency, injuring themselves, or trapping themselves in some way then the emergency indication mechanism may be activated which causes an emergency indication message to be transmitted. When the emergency message is transmitted the alarm mechanism will be activated. It will be appreciated that this gives added flexibility of enabling the member of the crew to manually indicate when an emergency situation occurs.

In one embodiment, the emergency indication mechanism is operable, in the event that the transceiver logic indicates that an emergency indication acknowledgement message has been transmitted over the local communications link in response to the emergency indication message, to activate the alarm mechanism.

Accordingly, by activating the alarm mechanism on receipt of the emergency indication acknowledgement message, the crew member can be assured that not only has the emergency indication message been transmitted, but that it has been received by the base unit.

In embodiments, the emergency indication mechanism is operable, in the event that no emergency indication acknowledgement message is received within a predetermined period of time, to retransmit the emergency indication message. In embodiments, the alarm mechanism comprises an audio-visual alarm mounted with the personal safety device and the base unit.

It will be appreciated that the audio-visual alarm may take any form such as, for example, a siren, claxon, light or flashing strobe device.

In embodiments, the base unit is coupled with a vessel and the alarm mechanism comprises a vessel propulsion interference device operable to interfere with the propulsion of the vessel.

Hence, the activation of the alarm mechanism causes interference with the propulsion of the vessel. It will be appreciated that this interference may take a number of forms such as, for example, an ignition inhibitor, an engine shutdown actuator or an auto-helm deactivator. Each of these mechanisms will cause the vessel's means of propulsion to stop, enabling the vessel to remain in the vicinity of the incident.

In embodiments, the personal safety system further comprises base unit location determination logic operable to determine a current position of the base unit and the alarm mechanism is operable when activated to cause the base unit location determination logic to determine a current position of the base unit and to cause an emergency indication message including the current position of the base unit to be transmitted over a communications link.

Hence, when the alarm mechanism is activated, the base unit location determination logic determines the present geographical location of the base unit and an emergency indication message is transmitted over a communications link which includes that geographical position. In this way, it will be appreciated that the precise location of the base unit when the incident occurs is readily recorded.

In embodiments, the personal safety system further comprises a control station operable to communicate with the base unit over the communications link and further operable upon receipt of the emergency indication message to activate an alarm and to indicate the position of the base unit.

When the emergency indication message is received at the control station, an alarm is indicated together with the position of the base unit. It will be appreciated that this information may then be provided to a search and rescue organisation.

In embodiments, wherein the base unit further comprises an emergency cancel mechanism operable, when activated, to cause an emergency cancel message to be transmitted over the communications link.

Accordingly, in the event that a false alarm occurs or any emergency is resolved, a message can be sent to inform the control station, thereby preventing any unnecessary search and rescue operation from being performed.

In embodiments, the emergency cancel mechanism is operable, in the event that no emergency cancel acknowledgement message is received over the communications link within a predetermined period of time, to retransmit the emergency cancel message.

In embodiments, the alert logic is operable, whilst the transceiver logic indicates that the status and acknowledgement messages are being transmitted between the personal safety device and the base unit, to activate a confidence indicator.

Accordingly, a confidence indictor will be activated whilst normal transmission occurs over the local communications link between the personal safety device and the base unit. It will be appreciated that this provides an ongoing assurance to the crewmember that the device is operating correctly and is being monitored by the base unit.

In embodiments, the alert logic is operable, when the transceiver logic indicates that the status and acknowledgement messages are not being transmitted between the personal safety device and the base unit, to activate a warning alarm.

Hence, the crew member can be provided with an indication that transmission between the personal safety device and the base unit may be being interrupted to enable the crew member to take remedial action prior to an alarm activating.

In embodiments, the personal safety device comprises a battery and battery status information detection logic operable to detect battery status information and to cause the transceiver logic to include battery status information at least periodically in messages transmitted to the base unit.

By transmitting battery status information it is possible to determine at the base unit the current battery status of each personal safety device. Hence, it may then be possible to alert the crewmember that the battery level of their personal safety device is running low. Also, this information can be used when reviewing an activated alarm to determine whether it is likely that a false alarm may have occurred due to low battery levels in the personal safety device.

In embodiments, the battery status information detection logic is operable, in the event that that the battery reaches less than a predetermined charge level, to cause the transceiver logic to transmit at least one personal safety device deactivating message to the base unit and to deactivate the personal safety device.

Hence, when the charge in the battery becomes less than a predetermined amount, one or more personal safety device deactivating messages are transmitted to the base unit to indicate to the base unit that the personal safety device will be deactivating and the personal safety device will thereafter deactivate. In this way, it will be appreciated that the occurrence of false alarms due to low battery levels causing erroneous transmissions will be reduced.

In embodiments, the battery status information detection logic is operable, in the event that no personal safety device deactivating acknowledgement message is received over the communications link within a predetermined period of time, to retransmit the personal safety device deactivating message.

In embodiments, the personal safety system further comprises repeater transceiver logic operable to increase a coverage range of the local communications link.

By providing repeater transceiver logic, the coverage provided in the area of the base unit can be significantly increased. For example, such repeater transceiver logic may be positioned in poor reception areas such as, for example, behind a superstructure or within a cargo hold or living quarters.

In embodiments, each personal safety device and base unit have associated therewith a unique identifier and each personal safety device and base unit comprises register logic operable to register a personal safety device with a base unit.

Accordingly, any personal safety device may be registered with any other base unit by registering the unique identifier of one with the other. In this way, it will be appreciated that crewmembers operating on different vessels each having its own base unit can readily register their personal safety device with that base unit following deregistration of their personal safety devices with the base unit of their previous vessel. Also, it will be appreciated that the unique identifier may be used to provide an indication of which crewmember is in an emergency situation to provide an indication of the severity of an incident. For example, should a vessel have only one competent skipper and it is he who is in an emergency situation then it is likely that the severity of that incident will be higher than may otherwise be the case.

According to a second aspect of the present invention there is provided a personal safety device operable to communicate with a base station over a local communications link, the personal safety device comprising: transceiver logic operable to transmit over the local communications link a periodic status message and to transmit an acknowledgement message generated in response any status messages received over the local communications link; and alert logic operable, in the event that the transceiver logic indicates that a number of either of the status and acknowledgement messages fail to be transmitted between the personal safety device and the base unit, to activate an alarm mechanism.

Embodiments of the personal safety device include features of the personal safety system of the first aspect of the present invention.

According to a third aspect of the present invention there is provided a base station operable to communicate with a personal safety device over a local communications link, the base station comprising: transceiver logic operable to transmit over the local communications link a periodic status message and to transmit an acknowledgement message generated in response any status messages received over the local communications link; and alert logic operable, in the event that the transceiver logic indicates that a number of either of the status and acknowledgement messages fail to be transmitted between the personal safety device and the base unit, to activate an alarm mechanism.

Embodiments of the base station include features of the personal safety system of the first aspect of the present invention.

According to a fourth aspect of the present invention there is provided a method of communicating between a personal safety device and a base unit, the method comprising the steps of transmitting a periodic status message or an acknowledgement message generated in response to a received status message between a personal safety device and a base unit over a local communications link, and activating an alarm mechanism on the personal safety device and the base unit alert logic, in the event that a number of either of the status and acknowledgement messages fail to be transmitted between the personal safety device and the base unit.

Embodiments of the method comprise method steps performed by the elements of the personal safety system of the first aspect of the present invention.

### BRIEF DESCRIPTION OF THE DRAWINGS

The present invention will be described further, by way of example only, with reference to preferred embodiments thereof as illustrated in the accompanying drawings, in which:

FIG. 1 illustrates a system for communicating with a vessel according to one embodiment;

FIG. 2 illustrates messaging between the vessel and control station illustrated in FIG. 1 when activating and deactivating position monitoring;

FIG. 3 illustrates failure in messaging between the vessel and control station illustrated in FIG. 1 when activating and deactivating position monitoring;

FIGS. 4 and 5 illustrate messaging between the vessel and control station illustrated in FIG. 1 during position monitoring;

FIG. 6 illustrates the structure and content of messages transmitted;

FIG. 7 illustrates in more detail an arrangement of the vessel shown in FIG. 1;

FIG. 8 illustrates messaging between the emergency positioning beacon and the control station when an emergency incident occurs;

FIG. 9 illustrates messaging between the emergency positioning beacon and the control station when varying the interval at which position messages are generated;

FIG. 10 illustrates messaging between the control station and the emergency positioning beacon when requesting updated position information;

FIG. 11 illustrates messaging between the emergency positioning beacon and the control station when the electronic positioning beacon is requested to cease transmission;

FIG. 12 illustrates an arrangement of a personal safety system according to one embodiment;

FIG. 13 illustrates messaging between the personal safety device and the base unit during start up and normal operation;

FIG. 14 illustrates messaging when the personal safety device goes out of range such as may occur when a crewmember falls off the vessel;

FIG. 15 illustrates messaging when an alarm is activated on the personal safety device;

FIG. 16 illustrates messaging used to cancel an emergency alarm; and

FIG. 17 illustrates a geofence arrangement.

### DESCRIPTION OF THE PREFERRED EMBODIMENTS

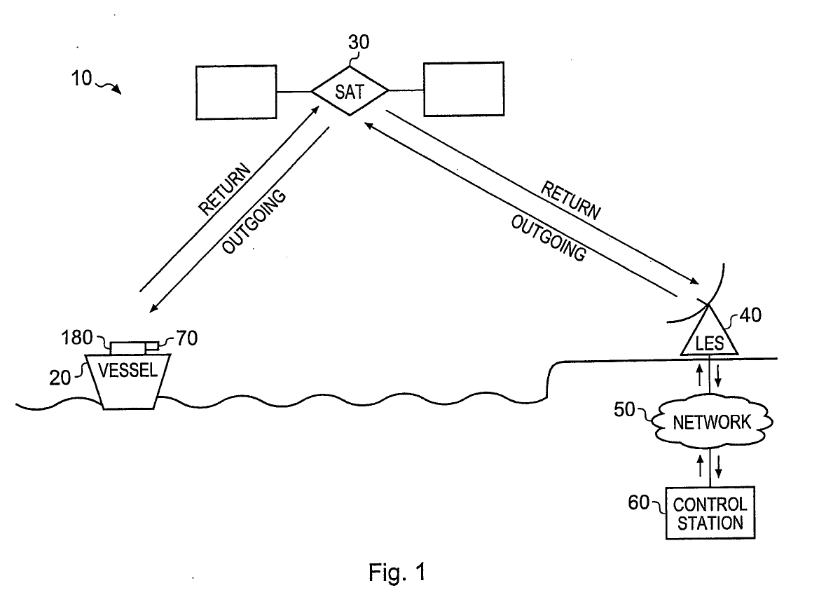

FIG. 1 illustrates a communication system according to an embodiment of the present invention. The communication system links a vessel 20 via a satellite 30 with a land earth station 40 using a communication link. The land earth station 40 is coupled via a network (for example, the internet) with a control station 60. Messages are transmitted over the communications link to provide an indication to the control station 60 of whether or not the vessel 20 is likely to be in an emergency situation.

In this example, the communication link is provided by the Inmarsat (trademark) D+ satellite network, which provides a low cost time division multiplexed bearer for transmission of data at a low bit rate. However, it will be appreciated that any suitable satellite (such as Iridium (trademark)) or other communications link (such as GSM) having an appropriate antenna arrangement could be utilised.

The Inmarsat (trademark) D+ satellite network provides a relatively high power outgoing channel linking the land earth station 40 via the satellite 30 with the vessel 20. The reliability of the outgoing channel is reasonably high due to the comparatively high power transmission performed by the land earth station 40.

The return channel from the vessel 20 via the satellite 30 to the land earth station 40 provides a comparatively less reliable transmission path due, in the main, to the comparatively low power of the transmission from the vessel 20. Accordingly, it will be appreciated that the reliability of messages transmitted over the outgoing channel will be generally higher than the reliability of the messages transmitted over the return channel.

A transceiver 70 is provided on the vessel 20 which, in accordance with one known technique, registers with the land earth station 40 using a bulletin board system to reserve a particular time slot in the return channel. The transceiver 70 is coupled with a base station 180. Data transmissions from the vessel 20 will then occur, as required, on the time slot allocated to the transceiver 70 on the vessel 20. In a typical Inmarsat (trademark) D+ arrangement, the transceiver 70 on the vessel 20 will be provided with a time slot at around every 2 minutes. Accordingly, it will be appreciated that a delay can occur of up to 2 minutes from when the vessel 20 may require to transmit a message to when an available time slot is available. Hence, messages to be transmitted over the return channel will typically be placed in a buffer until transmission can occur. For an Iridium (trademark) arrangement no two minute time slots exist and instead the data can be transmitted almost immediately. Therefore, transmission delays are significantly reduced.

Similarly, a time slot in the outgoing channel will be reserved for use by the land earth station 40 for transmitting data to the vessel 20. Hence, a latency of up to 2 minutes will also exist in any transmissions originating from the land earth station 40 for transmission to the vessel 20.

Accordingly, an end-to-end latency of around 4 minutes may occur following transmission of a message from the vessel 20 to the land earth station 40 to the time when a response from the land earth station 40 is received at the vessel 20, and vice versa. Also, further latency can occur should any buffering occur in the vessel 20, the satellite 30, the land earth station 40, the network 50 or the control station 60 the prior to transmitting or passing on received messages. For example, should the land earth station 40 not be able to forward messages via the network 50 to the control station 60 for whatever reason then these messages may also be buffered by the land earth station 40 until those messages can be forwarded.

In order to save power, the transceiver 70 on the vessel 20 may be deactivated during the periods outside its allocated time slots.

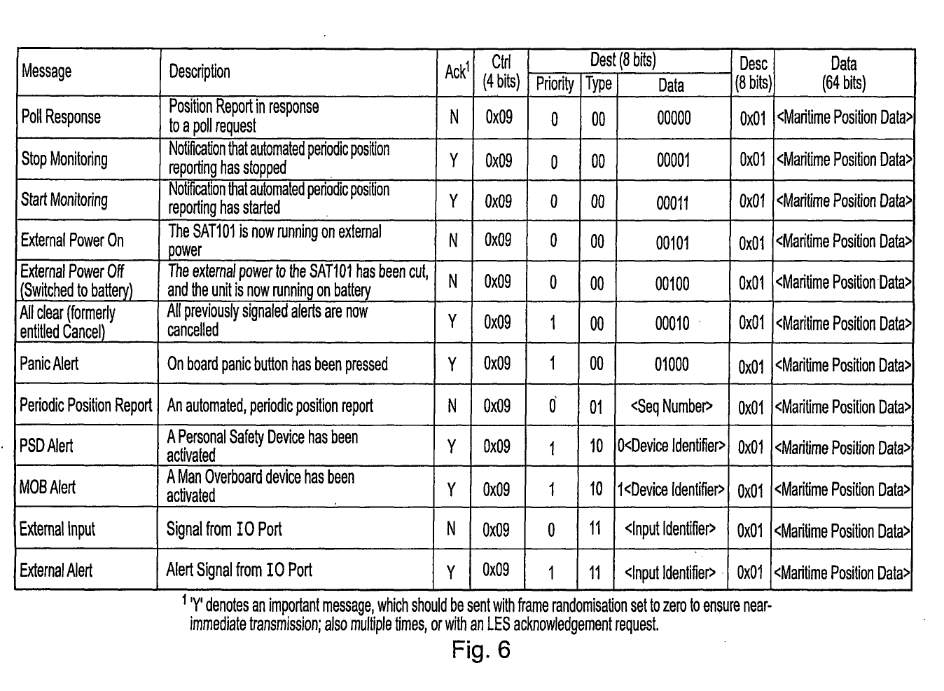

Data is transmitted over the Inmarsat (trademark) D+ satellite network in form of small packets. More detail on the contents of the packets will be described later with reference to FIG. 6.

As mentioned above, the reliability of the return channel is relatively low and the probability of a message not reaching its destination over the return channel is between 2% and 5% (this means that around one in 20 messages transmitted over the return channel will never be received). The absence of a message may be for two typical reasons. Firstly, the message may have been transmitted by the transceiver 70 but simply never received. Alternatively, the vessel 20 may be in an emergency situation and unable to transmit a message. However, in the absence of any mechanism to differentiate between these two events the safest assumption that the vessel 20 may be in an emergency situation. Accordingly, attempting to utilise the Inmarsat (trademark) D+ communications system to provide an indication to the control station 60 of whether or not the vessel 20 is likely to be in an emergency situation is likely to result in a large number of false alarms occurring due to the unreliability of the Inmarsat (trademark) D+communications system, making the system unusable.

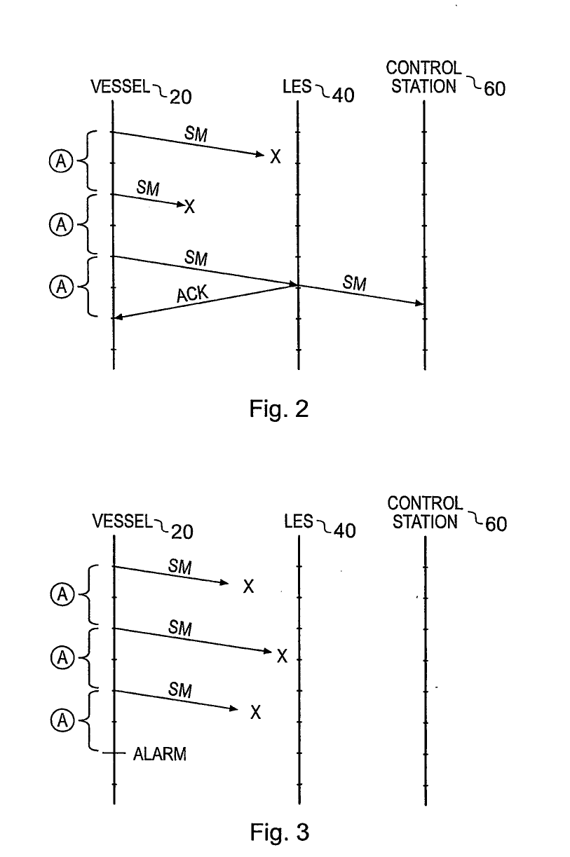

Hence, techniques are provided to effectively improve the reliability of the return communications channel, thereby decreasing the occurrence of false alarms. FIGS. 2 to 5 illustrate techniques employed by the communications system 10 in order to reduce the occurrence of false alarms.

FIG. 2 illustrates the communication between the vessel 20, land earth station 40 and the control station 50 when attempting to initiate vessel position monitoring.

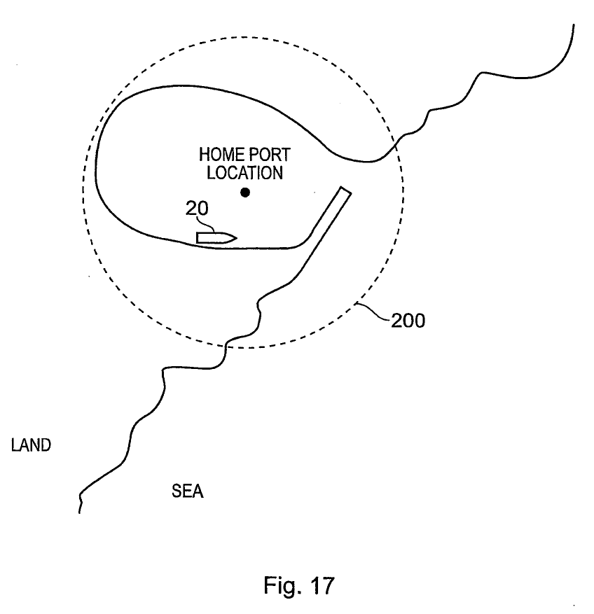

In the example shown in FIG. 2, the crew of the vessel 20 firstly switches on the position monitoring system by activating an “at sea” switch on the base station 180. Alternatively, in the event that the base station 180 determines that a geofence has been broken (as will be described in more detail with reference to FIG. 17), the “at sea” switch on the base station 180 will be automatically activated. Following a number of system checks and registration with the satellite 30, a start monitoring message is transmitted from the vessel 20 via the satellite 30 to the land earth station 40.

As illustrated in this example, the start monitoring message fails to reach the land earth station 40. This may be due to, for example, the vessel transmitter being obscured within a port or rough conditions causing the transceiver 70 to be in an incorrect orientation with respect to the satellite 30. The vessel 20 monitors the outgoing channel in order to determine whether a start monitoring acknowledgement signal has been received. After a time period A (which is a predetermined time period representative of the longest possible latency between the start monitoring message being transmitted by the vessel 20 and an acknowledgement message being received, in this case around 4 minutes), the vessel 20 will retransmit the start monitoring message.

Once again, in this example, the start monitoring message fails to reach the land earth station 40. Accordingly, after time period A, the vessel 20 will once again retransmit the start monitoring message.

In this example, the start monitoring message is received by the land earth station 40 and is forwarded via the network 50 to the control station 60. The control station 60 will register that the vessel 20 has requested that position monitoring be activated and registers the vessel 20 as a vessel to be monitored. The start monitoring message includes a bit field which, when decoded by the land earth station 40, automatically generates an acknowledgement message which is transmitted via the satellite 30 to the vessel 20.

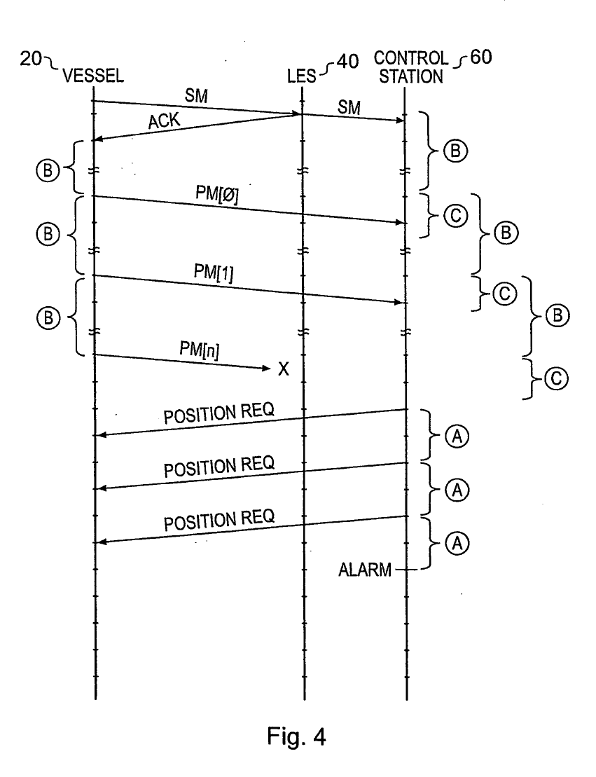

On receipt of the acknowledgement message, the base station 180 will indicate to the crew of the vessel 20 that position monitoring has been activated. Thereafter, as will be explained in more detail with reference to FIG. 4 below, the transceiver 70 will transmit periodic position information messages.

FIG. 3 illustrates the sequence of events when the start monitoring request fails. As with FIG. 2, the first and second start monitoring messages fail to reach the land earth station 40. However, in this example, the third start monitoring message also fails to reach the land earth station 40.

Accordingly, after the predetermined time period A, an alarm will be activated on the base station 180 to indicate to the crew of the vessel 20 that the request to initiate vessel position monitoring has failed to complete. On the occurrence of the alarm, the crew have the option of either restarting the request to initiate position monitoring, contacting the control station 60 for assistance or aborting the voyage.

Whilst in this example the start monitoring message is only transmitted twice, it will be appreciated that this message may be repeated any number of times. Also, whilst the predetermined time period A is set to be the maximum latency period of a transmission between the vessel 20 and the control station 60 and a return transmission, it will be appreciated that the time period A could be any other time period which is typically longer than this.

FIG. 4 illustrates in more detail the messages transmitted during position monitoring of the vessel 20.

As shown in FIG. 4, a start monitoring message transmitted by the vessel 20 is received by the land earth station 40, which issues a land earth station acknowledgment signal back to the vessel 20 and forwards the start monitoring message to the control station 60. Thereafter, the vessel 20 transmits position messages over the return channel at periodic intervals B.

The periodic interval B may be either preset within the base station 180 or can be set dynamically in response to control message sent by the control station 60 to the vessel 20. In a typical arrangement, the predetermined interval B may be anything from 5 minutes to 3 hours, but most commonly around 1 hour. It will be appreciated that by having a short periodic interval B, the likelihood of position information being received in any particular time period will be higher than for position messages having a longer periodic interval B. However, this increase is at the cost of increasing the bandwidth used on the return channel. Providing less frequent position information introduces a greater degree of uncertainty regarding the exact location of a vessel should that vessel fail to provide further position information and subsequently trigger an alarm.

After the periodic interval B following receipt of the land earth station acknowledgement message, the vessel 20 will transmit a first position message. The position message contains information on the position of the vessel 20 (as will be described in more detail with reference to FIG. 6). The position messages also contain a sequence number. In this example, the first position message is embedded with a sequence number “0”, with subsequent messages being numbered consecutively.

Meanwhile, the control station 60 will wait the periodic interval B following receipt of the start monitoring message after which receipt of the first position message is expected. The control station 50 will monitor the return channel during a window of time C following the periodic interval B. The control station 50 will expect to receive the first position message within this time window. The time window C is set to reflect the maximum possible latency between the vessel 20 requiring to transmit a position message and that position message actually being received by the control station 50. By setting this window, it will be appreciated that the incident of false alarms occurring due to transmission latency in the return channel is reduced.

Following transmission of the first position message, the vessel 20 waits during the periodic interval B prior to transmitting the next position message (position message 1) on the return channel.

Similarly, the control station 50 will wait during the periodic interval B prior to monitoring the return channel (within the time window C) for the receipt of the next position message, and so on.

However, in the event that, for whatever reason, a position message fails to be received by the land earth station 40, it will be appreciated that no position message will be provided to the control station 50 within the time window C.

Accordingly, following expiry of time period C, the control station 60 will realize that the expected position message from the vessel 20 has not been received. However, instead of simply activating an alarm at this point, the control station 60 will generate a position request message for transmission to the vessel 20. Because the position request message is transmitted on the outgoing channel, its transmission strength will be significantly higher than any position message transmitted on the return channel. Accordingly, there is a higher likelihood that the position request message will reach the vessel 20 in comparison with the position message being received by the land earth station 40.

The control station 60 will wait the predetermined period A for a position message to be received from the vessel 20. After the elapse of the time period A, the control station 60 will retransmit the position request message. Again, should a position message not be received from the vessel 20 within the allotted time period, then the position request message will be retransmitted once again to the vessel 20.

Should the transmission of three position request messages by the control station 60 not result in a position message being returned from the vessel 20 then it can be assumed that there is a high likelihood that the vessel 20 may be in an emergency situation. Although, in this example, three position request messages are transmitted, it will be appreciated that the optimal number of position request messages required to be transmitted will vary dependent upon the reliability of the particular implementation. Accordingly, an alarm will be activated in the control station 60. At this point, an alarm mechanism will issue a further position request message. Alternatively, an operator may issue the further position request message. Alternatively, or additionally, the alarm mechanism may attempt to automatically contact the vessel using predetermined contact information stored at the control station 60 and associated with the vessel 20. For example, a mobile telephone or a satellite telephone associated with the vessel 20 may be automatically dialed and a recorded message played indicating that it is believed that the vessel 20 may be in an emergency situation and asking that the control station 60 be contacted. Similarly, the vessel owners may be contacted. It will be appreciated that this process could either be automated or handled by an operator. Alternatively, or additionally, the most recent position information received by the control station 60 associated with the vessel 20, together with any previous position information can then be analysed in order to determine a probable location of the vessel 20. In the event that analysis of the position information leads to the likely conclusion that the vessel may be in a safe location (such as in port moored, at a buoy or in a known area of poor reception) then the decision to progress the incident further may be deferred.

Should the vessel 20 prove not to be contactable and the position information not indicate that the vessel 20 is unlikely to be in an emergency situation then the control station 60 will transmit the position information together with any relevant details of the vessel 20 stored by the control station 60 to a search and rescue organisation, such as the Coastguard.

Hence, it will be appreciated that through this approach, various mechanisms are provided to reduce the likelihood of a false alarm occurring due to the poor reliability of the return data channel and that only in the event that there is a high likelihood that a real incident has occurred will the incident data be passed to a search and rescue organisation and a search and search and rescue operation initiated.

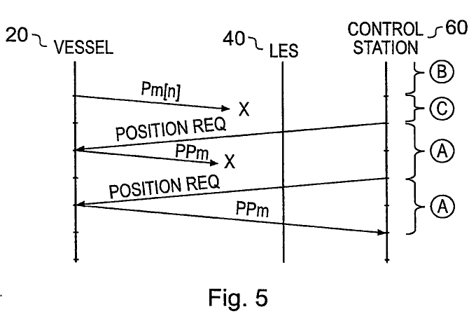

FIG. 5 illustrates a temporary loss of communication between the vessel 20 and the land earth station 40.

In a similar manner to FIG. 4, the vessel 20 transmits a number of position messages to the land earth station 40. However, one such message fails to be received by the land earth station 40. Hence, the control station 60 will fail to receive a position message within the time window C. Accordingly, the control station 60 will transmit a position request message to the vessel 20. In this example, the position request message is received by the vessel 20 which, in response, transmits a position response message over the return channel.

However, in this example, the position response message also fails to be received by the land earth station 40. Hence, following the time period A, the control station 60 will note that no position response message has been received. At that time, the position request message will be retransmitted to the vessel 20.

Once again, the position request message is received by the vessel 20 which retransmits the position response message. In this example, the position response message is received by the land earth station 40 and forwarded to the control station 60.

Now that the control station 60 has received a position response message from the vessel 20 no further incident action need occur and the position information is recorded. Thereafter, the vessel 20 will continue to transmit position messages at predetermined intervals B and the control station 60 will expect to receive these subsequent position messages within the time window C following the predetermined period B.

As mentioned above, in a typical arrangement, the predetermined period B will be anything from 5 minutes to 3 hours, the outgoing and return transmission latency A may be typically around 4½ minutes, whereas the time window C will typically be half that value, namely, just over 2 minutes.

FIG. 2 also illustrates the communication between the vessel 20, land earth station 40 and the control station 50 when attempting to terminate vessel position monitoring.

In the example shown in FIG. 2, the crew of the vessel 20 attempts to deactivate the position monitoring system by activating an “in port” switch on the base station 180. A stop monitoring message is transmitted from the vessel 20 via the satellite 30 to the land earth station 40.

As illustrated in this example, the stop monitoring message fails to reach the land earth station 40. This may be due to, for example, the vessel transmitter being obscured within a port or rough conditions causing the transceiver 70 to be in an incorrect orientation with respect to the satellite 30. The vessel 20 monitors the outgoing channel in order to determine whether a stop monitoring acknowledgement signal has been received. After the time period A, the vessel 20 will retransmit the stop monitoring message.

Once again, in this example, the stop monitoring message fails to reach the land earth station 40. Accordingly, after time period A, the vessel 20 will once again retransmit the stop monitoring message.

In this example, the stop monitoring message is received by the land earth station 40 and is forwarded via the network 50 to the control station 60. The control station 60 will register that the vessel 20 has requested that position monitoring be terminated and deregisters the vessel 20 as a vessel to be monitored. The stop monitoring message includes a bit field which, when decoded by the land earth station 40, automatically generates an acknowledgement message which is transmitted via the satellite 30 to the vessel 20.

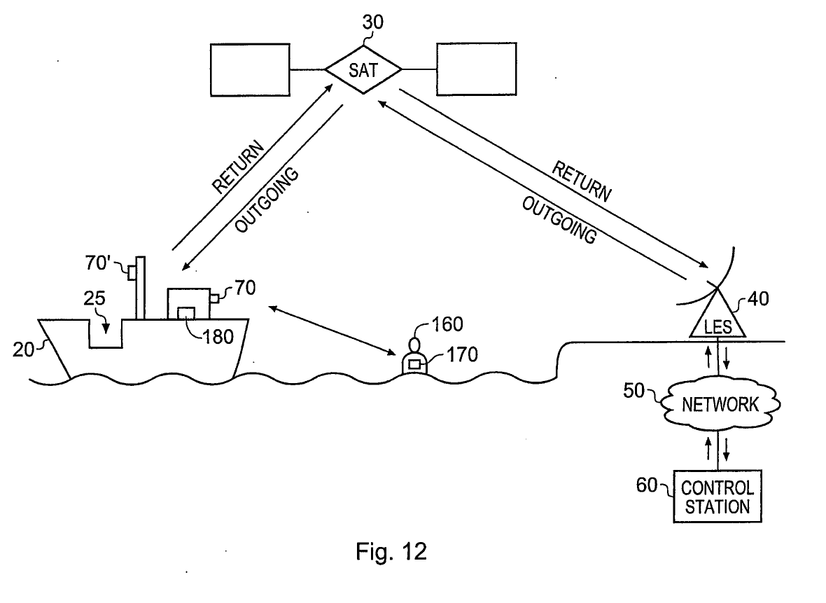

On receipt of the acknowledgement message, the base station 180 will indicate to the crew of the vessel 20 that position monitoring has been deactivated, the base station 180 will record the current location and store this as the home port location and the base station 180 will enter an “in port” state whereby the operation of a personal safety system as described with reference to FIG. 12 will continue and the current location of the vessel will continue to be monitored by the base station 180.

FIG. 3 illustrates the sequence of events when the stop monitoring request fails. As with FIG. 2, the first and second stop monitoring messages fail to reach the land earth station 40. However, in this example, the third stop monitoring message also fails to reach the land earth station 40.

Accordingly, after the predetermined time period A, an alarm will be activated on the base station 180 to indicate to the crew of the vessel 20 that the request to terminate vessel position monitoring has failed to complete. On the occurrence of the alarm, the crew have the option of either restarting the request to terminate position monitoring or contacting the control station 60 for assistance.

Whilst in this example the stop monitoring message is only transmitted twice, it will be appreciated that this message may be repeated any number of times. Also, whilst the predetermined time period A is set to be the maximum latency period of a transmission between the vessel 20 and the control station 60 and a return transmission, it will be appreciated that the time period A could be any other time period which is typically longer than this.

In this way, it will be appreciated that the vessel 20 is provided with a positive confirmation that the monitoring has been terminated and, hence, the position reporting may be deactivated without the risk of such deactivation resulting in a false alarm occurring.

Hence, the present technique provides a reliable messaging solution which enables unreliable (but low cost) message bearers to be utilised. This is because the major disadvantage of the unreliability can be overcome, whilst retaining the advantage of low cost. Hence, it is possible to provide the same reliability of messaging as would be provided with a higher reliability message bearer but without the penalty of significantly higher equipment and operating costs.

To illustrate this, in the present technique, when the vessel 20 starts its journey a start monitoring message is sent Under normal circumstances this message would have a probability of being delivered of approximately 95%. Following receipt of the acknowledgement message, the vessel 20 can guarantee that the start monitoring message has been received. As the vessel 20 continues its journey, it sends periodic position messages. Each message is sequence numbered (for example 0 to 31) so that the control station 50 can determine if a message has been lost due to channel unreliability or has simply been delayed. In the event that the control station 60 does not receive an expected position message, it sends a position request message to the vessel 20 to try to obtain the vessel position. This process in repeated typically, up to three times. This approach increases the likelihood that a position message is received by the control station from around 95% to around 99.8%. It will be appreciated that this provides a similar level of reliability to that of transmitting the acknowledgement message, but without the additional cost of having to transmit such a message every time a position message has been transmitted from the vessel 20. At then end of the vessel journey, the stop monitoring message is acknowledged with an acknowledgement message. Thus, only the start monitoring message and the stop monitoring message routinely incur the additional costs of transmitting an acknowledgement message over the outgoing channel. Accordingly, the vast majority of messages will not need to be acknowledged. It will be appreciated that this significantly reduces the operating costs. However, in the event that any of those messages suffer unreliability, a message will be generated to cause retransmission in an effort to increase the likelihood that the message will be received correctly.

FIG. 6 illustrates the structure and content of messages transmitted in the communication system. Any return long burst messages are interpreted by the application according to the Satamatics (trademark) Application Message Registry [GDN-0051]. The message format conforms with the standards laid out in [GDN-0051] but adopts an application-specific interpretation of the Destination bits, so that:
Bit 1 represents the message Priority
Bits 2 and 3 determine the Message type:
   00—Standard Message
   01—Periodic Position Report
   10—Personal Safety Device (PSD)/Man Overboard (MOB) Alert
   11—External Input
Bits 4 to 8 are data, to be interpreted according to the Message Type:
   Message Number—A number allowing the standard message to be identified.
   Sequence Number—Periodic position report messages are marked with a sequence number to allow the control station to distinguish between lost messages and delayed messages.
   PSD/MOB Identifier—Personal Safety Device (PSD) and Man Overboard (MOB) alert messages are marked with an Identifier to allow the control station to distinguish between one of 16 available PSD and 16 available MOB devices.
   Input Identifier—The input identifier allows the control station to distinguish which one of up to 32 external input signals has been activated.

The Maritime Position Data format is described in the Satamatics (trademark) Application Message Registry [GDN-0051] as set out below. There is no acknowledgement.

| S | E | | | | | | |
|---|---|---|---|---|---|---|---|
| Bit | Bit | Length | Field Name | Usage | Range | Present | Information |
| 1 | | 1 | Control Flag | 1: Other | | | Unique Identifier |
| | | | | | | | (with Application |
| | | | | | | | Identifier) |
| 2 | 4 | 3 | Application | 01: ITA | | | Unique Identifier |
| | | | Identifier | | | | (with Control |
| | | | | | | | Flag) |
| | | 1 | Priority Flag | | | | |
| | | 7 | Canned | | | | |
| | | | Message | | | | |
| | | | Number | | | | |
| | | 8 | ITA Message | 0x01: Marine | | | |
| | | | Identifier | Position Report | | | |
| | | | | (JRC Format) | | | |
| | | 1 | Hemisphere | 0: Northern | | | |
| | | | (N/S) | 1: Southern | | | |
| | | 7 | Latitude | | 0-90 | | |
| | | | degrees | | | | |
| | | 6 | Latitude | | 0-59 | | |
| | | | minutes | | | | |
| | | 7 | Latitude | | 0-99 | | |
| | | | minutes/100 | | | | |
| | | 1 | Hemisphere | 0: Eastern | | | |
| | | | (E/W) | 1: Western | | | |
| | | 8 | Longitude | | 0-180 | | |
| | | | degrees | | | | |
| | | 6 | Longitude | | 0-59 | | |
| | | | minutes | | | | |
| | | 7 | Longitude | | 0-99 | | |
| | | | minutes/100 | | | | |
| | | 8 | Speed | | 0-255 | | Kilometres per |
| | | | | | | | hour |
| | | 9 | Course | | 0-359 | | Degrees |
| | | 1 | Status | 0: GPS Fix | | | |
| | | | | Not Available | | | |
| | | | | 1: GPS Fix | | | |
| | | | | Valid | | | |
| | | 3 | Time since | | 0-7 | | Hours since last |
| | | | last GPS fix | | | | valid GPS reading |

Alphanumeric return channel messages can be sent using 6 bit encoding. The message structure is defined in “Return: User—Alphanumeric” in [GDN-0051] Satamatics (trademark) Application Message Registry. There is no acknowledgement.

The following messages are reserved to have a special meaning:

| Special Text | | |
|---|---|---|
| Message | Notes | Description |
| POB n | n is the textual | Used for signalling the |
| | representation of a | number of persons on |
| | positive integer. | board. |
| | The canned message | |
| | number should be set to 0 | |
| PSDIU n | n is the textual | Used for signalling the |
| | representation of a | number of PSD devices in |
| | positive integer | use. |
| | The canned message | |
| | number should be set to 0 | |

Canned messages can be supported by setting the canned message number to a value between 1 and 128 inclusive (0 is reserved for system messages, such as those defined in the table above). Under these circumstances, the 12 alphanumeric characters in the Message Data field are assumed to be comma separated values to be substituted into the canned message. For example, a canned message “Sailing to $1, estimated time of arrival $2 00 UTC” with data “Ramsgate, 14” would yield “Sailing to Rarsgate, estimated time of arrival 14 00 UTC”.

Dictionary encoded messages can be sent using the message structure defined in “Return: User—Dictionary” in [GDN-0051] Satamatics (trademark) Application Message Registry. There is no acknowledgement.

FIG. 17 illustrates the arrangement of a geofence 200 around a home port location of the vessel 20.

As mentioned above, when the base station 180 receives the acknowledgement message from the control station 60 indicating that monitoring has been deactivated and that the base station 180 should enter the in port state, the base station 180 will record the current location and store this as the home port location. A virtual geofence 200 is set up around the vessel 20. The geofence is typically located at a predetermined radius, such as 200 metres, around the home port location (this allows for normal drift and in-port manoeuvring). However, the geofence may be any other shape and have a variable distance from the home port location. The current position of the vessel 20 remains constantly monitored even when the base station 180 is in the in port state. In the event that the vessel 20 is determined to be outside the geofence 200, the “at sea” switch will be activated and the start monitoring sequence illustrated in FIG. 2 will be commenced. Typically, an alarm will also sound on the base station 180 to indicate that the vessel 20 has been taken to sea without the monitoring system being activated. The user of the monitoring system will be encouraged to enter crew details into the base station 180 for transmission to the control station 60.

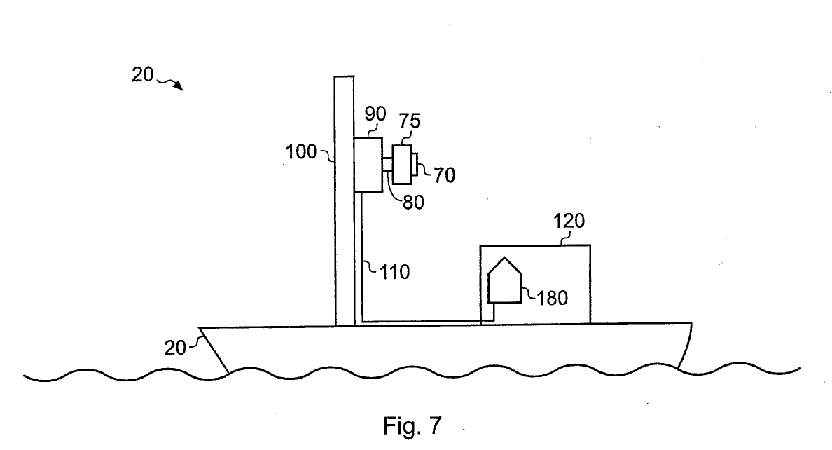

FIG. 7 illustrates in more detail a configuration of the vessel 20 shown in FIG. 1. The vessel 20 comprises a hull 140, a cabin 120 and a mast 100. Coupled with the mast 100 is a mount 90 for holding a release device 80 which is coupled with the emergency positioning beacon 75 housing the transceiver 70. The emergency positioning beacon 75 is coupled via the cable 110 to the base station 180 in the cabin 120. The transceiver 70 contains a transmitter for transmitting messages over the return channel and a receiver for receiving messages over the outgoing channel.

In normal operation of the vessel 20, the emergency positioning beacon 75 is retained on the mast. It will be appreciated that in this arrangement, the emergency position beacon 75 need not necessarily be arranged to transmit whenever the vessel 20 is at sea, but may simply begin transmissions when an emergency occurs, as will be described in more detail below.

Should an incident occur then the emergency positioning beacon 75 is detached from the vessel 20 either manually or automatically by the release device 80. When the emergency position beacon 75 is detached from the vessel 20 then a self-righting float mechanism deploys which causes the emergency positioning beacon 75 to deploy away from the vessel 20 and to float in the water in an orientation which enables communication over the outgoing channel and the return channel to be achieved. The activation of the release device 80 may occur due to, for example, the activation of a hydrostatic switch should the vessel 20 capsize.

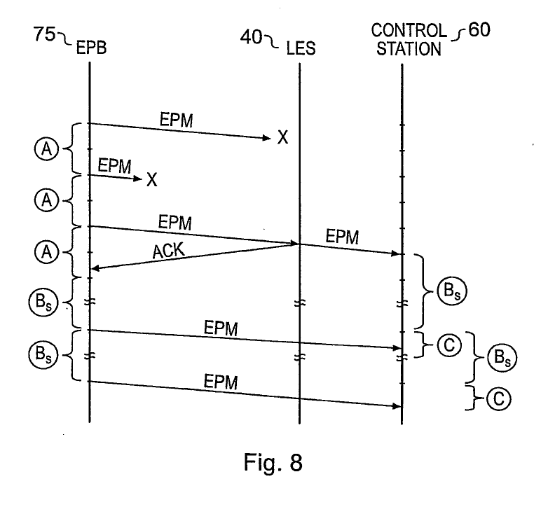

FIG. 8 illustrates the operation of the emergency positioning beacon 75 following activation in response to an emergency event. Once the emergency positioning beacon 75 has detected that an emergency event has occurred, due to, for example, a loss of connection to the base station 180 and/or the activation of a water sensing switch on the emergency position beacon 75 indicating that the emergency positioning beacon 75 is in contact with water, the emergency positioning beacon 75 will activate and, following system initialisation, will attempt to transmit an emergency position message during the next available time slot allocated to the emergency positioning beacon 75 by the communications system.

In the example shown, the first emergency positioning message fails to reach the land earth station 40 which may be due, for example, to an obstruction of the transceiver 70 during deployment Hence, after time period A, the emergency positioning beacon 75 will retransmit the emergency position message. In this example, the message once again fails to reach the land earth station 40. Accordingly, after another time period A, the emergency positioning message will be retransmitted once again. In this example, the emergency positioning message now reaches land earth station 40 and is forwarded on to the control station 60. In the meantime, the land earth station 40 transmits an emergency position acknowledgement message to the emergency positioning beacon 75. When the acknowledgement message is received by the emergency positioning beacon 75, an indication can be made on the beacon 75 that the land earth station 40 has received the emergency positioning message. It will be appreciated that this indication could take a variety of forms such as, for example, an intermittent flashing light on the emergency positioning beacon 75 itself. This indication will provide assurance to the crew that the emergency positioning beacon 75 is operating correctly and that an emergency positioning message has been successfully transmitted to the land earth station 40.

Thereafter, the emergency positioning beacon 70 will transmit periodic emergency position messages indicating the current position of the emergency position beacon 75. The rate at which these initial emergency positioning messages are transmitted may be relatively high such as, for example, every two minutes. Thereafter, either following a predetermined length of time or in response to a periodic interval change request message the emergency positioning beacon 75 may switch to transmitting emergency position messages at a less frequent rate in order to conserve power.

When utilising an Iridium (trademark) link between the emergency positioning beacon 75 and the control station 60, voice data may also be transmitted between the emergency positioning beacon 75 and the control station 60.

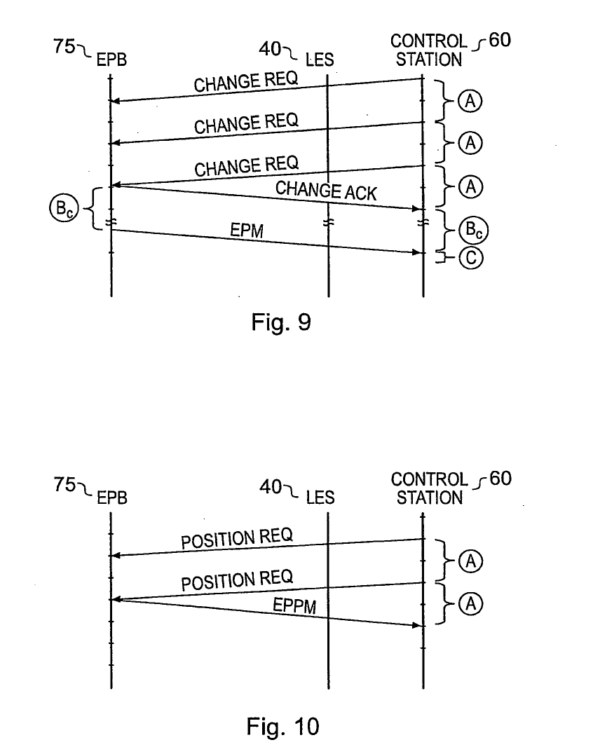

FIG. 9 illustrates controlling the emergency position beacon 75 remotely in order to adjust the rate at which emergency position messages are transmitted. The control station 60 will generate a change periodic interval request message which contains information indicating the required time which should elapse between transmitting each emergency position message.

The change periodic interval request message is transmitted to the emergency positioning beacon 75. In the event that the control station 60 fails to receive, within the time interval A, an acknowledgement from the emergency positioning beacon 75 that the change periodic interval request message has been received, the control station 60 will retransmit the change periodic interval request message once more. The control station 60 will continue to retransmit these messages until an acknowledgement from the emergency positioning beacon 75 is received. Thereafter, the electronic positioning beacon 75 will transmit emergency position messages at a rate indicated within the change periodic interval request message. Similarly, the control station 60 will expect to receive the next emergency position message shortly after the expiry of the new periodic interval. It will be appreciated that varying the interval at which the emergency positioning messages are transmitted will affect the power consumption of the emergency positioning beacon 75. Also, varying the rates at which these messages are transmitted will vary the accuracy by which the emergency position beacon 75 may be located and, accordingly, affect the likely search and rescue area.

FIG. 10 illustrates the messaging required to perform an on-demand position request The control station 60 will generate an on-demand positioning request message which is transmitted to the emergency positioning beacon 75 on the appropriate timeslot Should an emergency position message not being received by the control station within the time period A, the on-demand position request message will be retransmitted. These messages will continue to be retransmitted until a response is received.

On receipt of an on-demand position request message, the emergency positioning beacon 75 will generate an emergency position message indicating its current position. This emergency position message will be transmitted using the return channel to the control station 60. Accordingly, it can be seen that as well as periodic position information being provided by the emergency position beacon 75, it is possible to remotely interrogate the electronic position beacon 75 and force it to provide a current position status, independent of any periodic position messages. It will be appreciated that this provides a significant benefit to any search and rescue organisation when conducting its search and rescue operations.

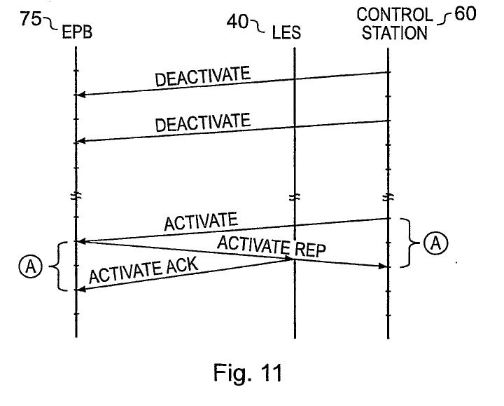

FIG. 11 illustrates the messaging required to support shutdown of the emergency positioning beacon 75. It is often the case that following the completion of a search and rescue operation, it is either not operationally possible or not economically justified to recover the emergency positioning beacon 75 itself. Hence, following the conclusion of the search and rescue operation, the beacon 75 may continue to transmit emergency messages. It will be appreciated that this is undesirable.

Accordingly, a shut down message may be transmitted from the control station 60 via the outgoing channel to the emergency positioning beacon 75. This shut down message will be continued to be transmitted until no further messages are received from the emergency positioning beacon 75.

On receipt of the shut down message, the emergency positioning beacon 75 will cease to transmit any further messages. Also, the emergency positioning beacon 75 may provide an indication that the transmission from this beacon has been deactivated by the control station 60. The electronic positioning beacon 75 may continue to monitor the outgoing channel for any subsequent control messages requesting that, for example, the beacon 75 be reactivated. Also, a mechanism may be provided on the electronic positioning beacon 75 to enable transmission to be manually reactivated.

It will be appreciated that by simply putting the electronic positioning beacon 75 into a monitoring state, rather than shutting down completely, it would be possible to recover from an erroneous stop transmitting message being received. Also, by enabling transmission to be manually reactivated it would be possible to alert the search and rescue organisation to the fact that a real incident has occurred should that organisation have discounted the transmission of emergency positioning messages as being a false alarm.

FIG. 12 illustrates an arrangement of a personal safety system according to an embodiment. The personal safety system comprises a personal safety device 170, worn by a crewmember 160, which communicates with the vessel 20 using either the transceiver 70 or the repeater transceiver 70′. One or more repeater transceivers 70′ may be provided in order to provide communications coverage in particular communications blackspot areas of the vessel 20 such as, for example, a hold or in a habitation area For the purposes of clarity, the following embodiments describes communication with the transceiver 70, however, it will be appreciated that communication could be instead with any of the repeater transceivers 70′ providing additional communications coverage.

Each crewmember onboard the vessel 20 carries a personal safety device 170. The personal safety device 170 is designed to be lightweight and easily wearable, either on a key fob, attached to a lifejacket or on a necklace cord. Each personal safety device 170 incorporates a battery and a bluetooth transceiver. The base unit 180 also includes a blue tooth transceiver.

Each personal safety device 170 is paired with the base unit 180. It will be appreciated that by providing the facility to pair different personal safety devices 170 with different base units 180 enables a crewmember 160 to retain a personal safety device 170 of their own and still operate on different vessels.

When removed from the base unit 180 the personal safety device 170 transmits at frequent regular intervals. The request message includes a unique identifier for that personal safety device. Typically, a personal safety device 170 is provided for each member of the crew.

The personal safety device 170 maintains a two-way communication link with the transceiver 70. This two-way communications maintains proximity detection of the crewmember 160. Should communications between the personal safety device 170 and the transceiver 70 be broken then this may indicate that the crewmember 160 is in an emergency situation For example, communication may be lost due to the crewmember 160 falling overboard and drifting out of range, or due to water immersion of the personal safety device 170 blocking transmission.

Also, the personal safety device 170 is provided with an emergency actuator which, once activated, causes an emergency message to be transmitted from the personal safety device to the transceiver 70.

In either event, an alarm will sound on the vessel 20 to indicate that a crewmember 160 may be in an emergency situation. In addition, should communication with the transceiver 70 be lost then the personal safety device 170 will activate an audio visual alarm which indicates to the crewmember 160 that an alarm will have been activated on the vessel 20. Should an alarm occur on the vessel 20 then, as will be explained in more detail below, an emergency message is transmitted over the return channel via the satellite 30, the land earth station 40 and the network 50 to the control station 60. The emergency message will indicate the nature of the emergency (a man-overboard alert or a self-activated alarm) together with the position of the vessel 20 when the alarm occurred. Further information such as a vessel identifier, the number of crewmembers and which crewmember is in an emergency situation may also be provided.

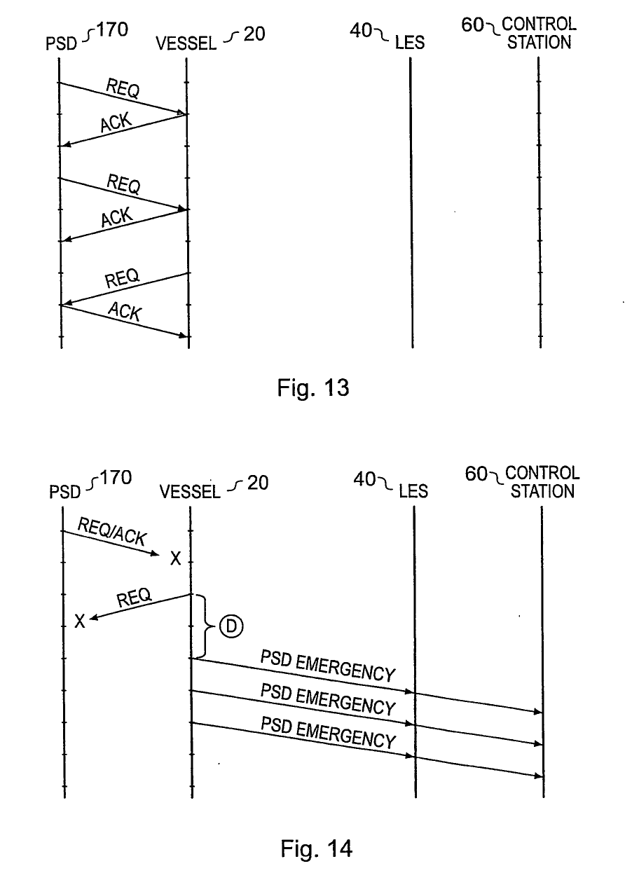

FIG. 13 illustrates the proximity-detecting feature of the personal safety device 170. In normal operation, once enabled, the personal safety device 170 periodically communicates with the transceiver 70. A request message is transmitted between the personal safety device 170 and the transceiver 70, when received an acknowledgement signal is sent in reply.

Communication between the personal safety device 170 and the transceiver 70 or the repeater transceiver 70′ occurs using a bluetooth link. In accordance with normal bluetooth protocols, it will be appreciated that either the personal safety device 170 or the transceiver 70 can initiate a request message. Should either the personal safety device 170 or the transceiver 70 not receive a request or an acknowledgement for a predetermined period of time then a request message may be transmitted. Hence, it would be appreciated that in this way, the personal safety device 170 and the transceiver 70 continually handshake to provide an assurance that these devices are in range of each other. As long as the personal safety device 170 continues to communicate with the transceiver 70 a visual confidence light flashes, typically every eight seconds, on the personal safety device 170 to provide an indication to the crew member 160 that the personal safety device 170 is communicating correctly with the transceiver 70. Similarly, a visual indicator is provided on the base unit 180 to indicate that communication is established with that crewmember 160.

FIG. 14 illustrates in more detail the flow of messages which occurs should the personal safety device 170 and the transceiver 70 fail to communicate with each other. In this example, a request or acknowledgement message sent from the personal safety device 170 to the transceiver 70 fails to reach the transceiver 70.

After a predetermined period of time, the transceiver 70 detects that no message has been received from the personal safety device 170 for that predetermined period of time and, accordingly, transmits a request message to the personal safety device 170. At around the same time, a first timer which has been running in the personal safety since the previous transmission or reception indicates that the predetermined period has expired and activates a warning alarm to indicate to the crew member that communications between the transceiver 70 and the personal safety device 170 have been interrupted to enable to crew member to take remedial action. A similar indication may be provided on the base unit 180. Once again, in this example, the request message fails to be received by the personal safety device 170. This failure in the communications link may be due to, for example, the crew member 160 falling overboard, the crew member 160 leaving the vessel 20 but not deregistering the personal safety device 170 with the base station 180 first, or the crew member 160 simply being in a poor communications location on the vessel 20.

Should the transceiver 70 fail to establish communication with the personal safety device 170 for the predetermined period of time D (which is longer than the period measured by the first timer in the personal safety device 170) then the transceiver 70 causes the position of the vessel 20 to be determined and transmits a PSD emergency message which contains this position information, together with an indication that a crew member may be in the water over the return channel to the land earth station 40 and onto the control station 60. In this example, the PSD emergency message is typically transmitted three times. Further information such as a vessel identifier, the number of crewmembers and which crewmember is in an emergency situation may also be provided.

Meanwhile, the personal safety device 170 also detects that communication with the base station 180 has been lost and will activate an audio-visual alarm to provide an indication to the crew member 160 that the PSD emergency message will have been transmitted by the transceiver 70. Typically, the personal safety device 170 will active the audio-visual alarm when a second timer which has been running in the personal safety since the previous transmission or reception indicates that the period of time D has expired. On receipt of the PSD emergency message, the control station 60 will forward relevant information to a search and rescue organisation. In conjunction with this, the control station 60 may review the position information received and also attempt to contact the vessel 20 in order to determine whether or not the PSD emergency message is likely to be a false alarm. Assuming that a false alarm is unlikely then the control station 60 may periodically pole the vessel 20 in order to obtain updated position information as required. Meanwhile, the position information recorded by the base station 180 will be stored and displayed in order to provide the remaining crew members with the position of the vessel when the crew member 160 may have been in an emergency situation.

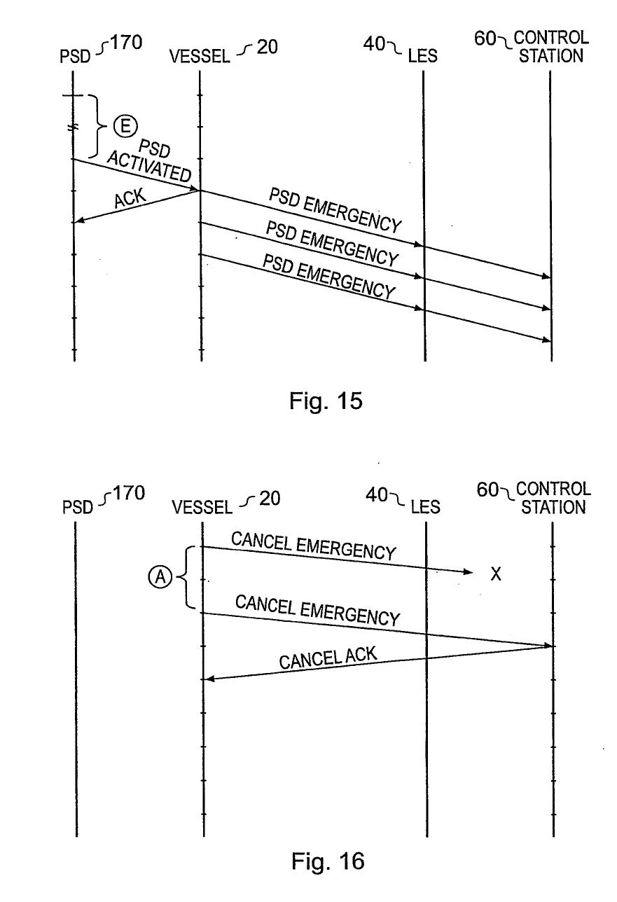

FIG. 15 illustrates the signalling which occurs when the crewmember 160 activates an emergency button on the personal safety device 170. Should the crew member 160 press and hold the emergency button for a predetermined period such as, for example, five seconds then the personal safety device 170 will transmit a PSD activated message to the transceiver 70. Depressing the button allows the crewmember 160 to raise an alarm under any circumstances, including an onboard emergency such as when trapped by machinery.

The transceiver 70 will transmit an acknowledgement message back to the personal safety device 170. On receipt of the acknowledgement message, the personal safety device 170 will activate an audio-visual alarm to provide an indication to the crew member 160 that the PSD activated message has been received by the transceiver 70. Meanwhile, an alarm will sound on the vessel 20 and an indication that a personal safety device has been activated will be displayed on the base station 180.

Upon receipt of the PSD activated message, the transceiver 70 will transmit a PSD emergency message over the return channel to the manned earth station 40 and onto the control station 60. The PSD emergency message will provide an indication that a PSD alarm button has been activated and also provide position information of the vessel 20. Further information such as a vessel identifier, the number of crewmembers and which crewmember is in an emergency situation may also be provided. In this example, the PSD emergency message is also typically transmitted three times.

Upon receipt of the PSD emergency message, the control station 60 will forward position information of the vessel 20 to a search and rescue organisation. Meanwhile, personnel at the control station 60 may attempt to contact the vessel in order to determine whether or not the PSD emergency message is a false alarm.

FIG. 16 illustrates which occurs in order to cancel a PSD emergency message. Should the emergency onboard the vessel 20 be resolved or should it be determined by the vessel 20 that a false alarm occurred then a cancel emergency message is transmitted over the return channel to the land earth station and onto the control station 60. The cancel emergency message is retransmitted periodically until a cancel acknowledgement message is received in return. In this way, it will be appreciated that the vessel 20 can safely and reliably cancel an emergency message when appropriate to do so in order to prevent a false alarm from occurring and causing an unnecessary search and rescue operation from being launched.

Hence, in a man overboard situation, the personal safety device 170 may become immersed in water and the bluetooth radio signal is attenuated. This prevents the regular transmission between the personal safety device 170 and the transceiver 70. When an emergency is detected, the base station 180 can raise the alarm by sounding a buzzer, or klaxon or similar audio device and also provide a visual indication by means of a flashing light or a display message. When a emergency is detected, the base unit 180 accurately records the current geographical position using a global positioning system, making it easier for the vessel 20 to turn around and steer a course back to where the man overboard is likely to be. This information is also routed to the search and rescue services, if required. This is particularly beneficial for single handed vessels. Also, using the Inmarsat (trademark) D+ system, the speed of the notification is significantly faster than those using emergency position beacons to transmit an alert to an earth orbiting satellite in order to relay the man overboard incident to the search and rescue organisation. Using such an emergency position indicating radio beacon can take around 20 minutes, whereas when using the Inmarsat (trademark) D+communications channel, a notification can be routinely transmitted in less than two minutes. Other satellite bearers, such as Iridium (trademark) do not employ transmission data slots as in Inmarsat (trademark) D+ and can, therefore, provide even faster notification. When a person is in the water, this time saving from the personal safety device 70 can make the difference between life and death. Also, by using the D+ or Iridium (trademark) system, two-way communications is supported.

It will be appreciated that using the bluetooth communications protocol provides an extremely robust transmission link between the personal safety device 170 and the transceiver 70. The transmission also has a low susceptibility to interference, which helps to reduce the number of false alarms.

On the occurrence of an emergency alarm at the base station 180, a stop vessel switch is activated to cut out any engines in order to reduce the distance between the vessel 20 and the crewmember 160 who may be overboard. This stop vessel switch could also take the form of an auto-helm deactivator on a yacht. It will be appreciated that these features are particular advantageous for single-crewed vessels.

The personnel safety device 70 also transmits routinely battery level information to the transceiver 70. It is important that the personnel safety device 170 maintains a particular level of charge in its battery in order to prevent false alarms occurring. Hence, the battery level can be monitored and an indication can be provided on the base station 180 when an individual battery level reaches a predetermined level. At that point, the crewmember 160 can be informed that his batteries need to be recharged and a low battery alarm on the personnel safety device 170 will be activated. Should the batteries not be recharged and the battery levels in the personal safety device 170 reach a critically low level then the personal safety device 170 will transmit a deactivation message to the transceiver 70 to inform the base station 180 that the personal safety device 170 will cease to continue transmitting. On receipt of a deactivation acknowledgement message from the transceiver 70 the personal safety device will cease transmitting and the confidence indicator will be deactivated.

The personnel safety device 170 may also be provided with a simple display and data input device which would enable, for example, text messages to be transmitted between the base station 180 and the personnel safety device 170. Text messages can also be provided from the control station 60 and routed to the personal safety device 170. Likewise, the base station 180 may also be provided with a simple display and data input device which would enable, for example, text messages to be transmitted between the base station 180, the control station 60 and the personal safety device 170. It will be appreciated that these text messages may either be freeform or pre-programmed templates.

Although illustrative embodiments of the invention have been described herein with reference to the accompanying drawings, it is to be understood that the invention is not limited to those precise embodiments, and that various changes and modifications can be affected therein by one scope in the art without departing from the scope of the invention as defined by the appended claims.

1-50. (canceled)

51. A personal safety system for a maritime vessel, comprising:
a personal safety device and a base unit coupled over a local communications link, said base unit being coupled to a control station via a further communications link to enable monitoring of said vessel by said control station;
transceiver logic operable to transmit a periodic status message and an acknowledgement message generated in response to each received status message between said personal safety device and said base unit over said local communications link; and
alert logic operable, in the event that said transceiver logic indicates that a number of either of said status and acknowledgement messages fail to be transmitted between said personal safety device and said base unit, to activate an alarm mechanism on said personal safety device and said base unit; wherein
said base unit is operable
to monitor a current position of said maritime vessel with respect to a geofenced area, and
in the event that the maritime vessel exits the geofenced area, to sound an alarm, to invite entry of crew details into said base unit, and to transmit said entered crew details to the control station over said further communications link.

52. The personal safety system as claimed in claim 51, wherein
said base unit is responsive to a message from said control station indicating that monitoring of said vessel has been deactivated to record a current position of said vessel and store this as a port location, and to set up said geofenced area around said stored port location; and
said base unit is operable, in the event that the maritime vessel exits the geofenced area, to initiate reactivation of monitoring of said vessel by said control station.

53. The personal safety system as claimed in claim 51, wherein said alarm mechanism on said personal safety device and said alarm mechanism on said base unit each comprise a timer and an alarm, each of said alarm mechanisms being operable on activation to start said timer and to activate said alarm when a time period measured by said timer expires, said time period measured by said timer of said alarm mechanism on said personal safety device being shorter than said time period measured by said timer of said alarm mechanism on said base unit.

54. The personal safety system as claimed in claim 53, wherein said alarm on said personal safety device is activated as a warning alarm when said time period measured by said timer on said personal safety device expires.

55. The personal safety system as claimed in claim 54, wherein said alarm mechanism on said personal safety device comprises a further timer operable to measure the time period measured by said timer of said alarm mechanism on said base unit and said alarm on said personal safety device is activated as an incident alarm when said time period measured by said further timer on said personal safety device expires.

56. The personal safety system as claimed in claim 51, wherein said alert logic is operable to deactivate said alarm mechanism on said personal safety device and said alarm mechanism on said base unit in the event that said transceiver logic indicates that either of said status and acknowledgement messages are transmitted between said personal safety device and said base unit.

57. The personal safety system as claimed in claim 51, wherein said personal safety device further comprises an emergency indication mechanism, said transceiver logic is operable, in the event that said emergency indication mechanism is activated, to cause an emergency indication message to be transmitted over said local communications link and said alert logic is operable, in the event that said transceiver logic indicates said emergency indication message has been transmitted over said local communications link, to activate said alarm mechanism.

58. The personal safety system as claimed in claim 57, wherein said emergency indication mechanism is operable, in the event that said transceiver logic indicates that an emergency indication acknowledgement message has been transmitted over said local communications link in response to said emergency indication message, to activate said alarm mechanism.

59. The personal safety system as claimed in claim 58, wherein said emergency indication mechanism is operable, in the event that no emergency indication acknowledgement message is received within a predetermined period of time, to retransmit said emergency indication message.

60. The personal safety system as claimed in claim 51, wherein said alarm mechanism comprises an audio-visual alarm mounted with at least one of said personal safety device and said base unit.

61. The personal safety system as claimed in claim 51, wherein said base unit is coupled with a vessel and said alarm mechanism comprises a vessel propulsion interference device operable to interfere with the propulsion of said vessel.

62. The personal safety system as claimed in claim 51, further comprising base unit location determination logic operable to determine a current position of said base unit and wherein said alarm mechanism is operable when activated to cause said base unit location determination logic to determine a current position of said base unit and to cause an emergency indication message including said current position of said base unit to be transmitted over a communications link.

63. The personal safety system as claimed in claim 62, further comprising a control station operable to communicate with said base unit over said communications link and further operable upon receipt of said emergency indication message to activate an alarm and to indicate said position of said base unit.

64. The personal safety system as claimed in claim 62, wherein said base unit further comprises an emergency cancel mechanism operable, when activated, to cause an emergency cancel message to be transmitted over said communications link.

65. The personal safety system as claimed in claim 64, wherein said emergency cancel mechanism is operable, in the event that no emergency cancel acknowledgement message is received over said communications link within a predetermined period of time, to retransmit said emergency cancel message.

66. The personal safety system as claimed in claim 51, wherein said alert logic is operable, whilst said transceiver logic indicates that said status and acknowledgement messages are being transmitted between said personal safety device and said base unit, to activate a confidence indicator.

67. The personal safety system as claimed in claim 51, wherein said alert logic is operable, when said transceiver logic indicates that said status and acknowledgement messages are not being transmitted between said personal safety device and said base unit, to activate a warning alarm.

68. The personal safety system as claimed claim 51, wherein said personal safety device comprises a battery and battery status information detection logic operable to detect battery status information and to cause said transceiver logic to include battery status information at least periodically in messages transmitted to said base unit.

69. The personal safety system as claimed in claim 68, wherein said battery status information detection logic is operable, in the event that said battery reaches less than a predetermined charge level, to cause said transceiver logic to transmit at least one personal safety device deactivating message to said base unit and to deactivate said personal safety device.

70. The personal safety system as claimed in claim 69, wherein said battery status information detection logic is operable, in the event that no personal safety device deactivating acknowledgement message is received over said communications link within a predetermined period of time, to retransmit said personal safety device deactivating message.

71. The personal safety system as claimed in claim 51, further comprising repeater transceiver logic operable to increase a coverage range of said local communications link.

72. The personal safety system as claimed in claim 51, wherein each personal safety device and base unit have associated therewith a unique identifier and each personal safety device and base unit comprises register logic operable to register a personal safety device with a base unit.

73. A base station for a maritime vessel operable to communicate with a personal safety device over a local communications link, said base unit being coupled to a control station via a further communications link to enable monitoring of said vessel by said control station, said base station comprising:
transceiver logic operable to transmit over said local communications link a periodic status message and to transmit an acknowledgement message generated in response to any status messages received over said local communications link; and
alert logic operable, in the event that said transceiver logic indicates that a number of either of said status and acknowledgement messages fail to be transmitted between said personal safety device and said base unit, to activate an alarm mechanism; wherein
said base unit is operable
to monitor a current position of said maritime vessel with respect to a geofenced area, and
in the event that the maritime vessel exits the geofenced area, to sound an alarm, to invite entry of crew details into said base unit, and to transmit said entered crew details to the control station over said further communications link.

74. A personal safety device for a maritime vessel operable to communicate with a base station according to claim 73 over a local communications link, said personal safety device comprising:
transceiver logic operable to transmit over said local communications link a periodic status message and to transmit an acknowledgement message generated in response to any status messages received over said local communications link; and
alert logic operable, in the event that said transceiver logic indicates that a number of either of said status and acknowledgement messages fail to be transmitted between said personal safety device and said base unit, to activate an alarm mechanism.

75. A personal safety method for a maritime vessel, the method comprising the steps of:
monitoring said vessel at a control station using a communications link;
transmitting a periodic status message or an acknowledgement message generated in response to a received status message between a personal safety device and a base unit over a local communications link; and
activating an alarm mechanism on said personal safety device and said base unit alert logic, in the event that a number of either of said status and acknowledgement messages fail to be transmitted between said personal safety device and said base unit;
monitoring a current position of said maritime vessel with respect to a geofenced area, and
in the event that the maritime vessel exits the geofenced area, sounding an alarm, inviting entry of crew details into said base unit, and transmitting said entered crew details to the control station over said further communications link.

76. The method as claimed in claim 75, further comprising the step of:
deactivating said alarm mechanism on said personal safety device and said alarm mechanism on said base unit in the event that either of said status and acknowledgement messages are transmitted between said personal safety device and said base unit.

77. The method as claimed in claim 76, further comprising the steps of:
activating an emergency indication mechanism; and
transmitting an emergency indication message over said local communications link.

78. The method as claimed in claim 77, further comprising the step of:
activating said alarm mechanism in the event that an emergency indication acknowledgement message has been transmitted over said local communications link in response to said emergency indication message.

79. The method as claimed in claim 78, further comprising the step of:
retransmitting said emergency indication message in the event that no emergency indication acknowledgement message is received within a predetermined period of time.

80. The method as claimed in claim 75, wherein said step of activating an alarm mechanism comprises activating an audio-visual alarm mounted with at least one of said personal safety device and said base unit.

81. The method as claimed in claim 75, wherein said step of activating an alarm mechanism comprises activating a vessel propulsion interference device operable to interfere with the propulsion of a vessel housing said base station.

82. The method as claimed in claim 75, further comprising the steps of:
determining a current position of said base unit; and
transmitting an emergency indication message including said current position of said base unit over a communications link.

83. The method as claimed in claim 82, further comprising the step of:
receiving said emergency indication message at a control station; and
activating and alarm and indicating said position of said base station at said control station.

84. The method as claimed in claim 81, further comprising the step of:
transmitting an emergency cancel message over said communications link.

85. The method as claimed in claim 84, further comprising the step of:
retransmitting said emergency cancel message in the event that no emergency cancel acknowledgement message is received over said communications link within a predetermined period of time.

86. The method as claimed in claim 75, further comprising the step of:
activating a confidence indicator whilst said status and acknowledgement messages are being transmitted between said personal safety device and said base unit.

87. The method as claimed in claim 75, further comprising the step of:
activating a warning alarm when said status and acknowledgement messages are not being transmitted between said personal safety device and said base unit.

88. The method as claimed in claim 75, further comprising the steps of:
detecting battery status information of said personal safety device; and
including battery status information at least periodically in messages transmitted to said base unit.

89. The method as claimed in claim 88, further comprising the steps of:
transmitting at least one personal safety device deactivating message to said base unit; and
deactivating said personal safety device in the event that said battery status information reaches less than a predetermined charge level.

90. The method as claimed in claim 89, further comprising the step of:
retransmitting said personal safety device deactivating message in the event that no personal safety device deactivating acknowledgement message is received over said communications link within a predetermined period of time.

91. The method as claimed in claim 75, further comprising the step of:
providing repeater transceiver logic operable to increase a coverage range of said local communications link.

92. The method as claimed in claim 75, wherein each personal safety device and base unit have associated therewith a unique identifier and said method further comprises the step of:
registering a personal safety device with a base unit.

93. The method as claimed in claim 75, wherein said alarm mechanism on said personal safety device and said alarm mechanism on said base unit each comprise a timer and an alarm, each of said alarm mechanisms being operable on activation to start said timer and to activate said alarm when a time period measured by said timer expires, said time period measured by said timer of said alarm mechanism on said personal safety device being shorter than said time period measured by said timer of said alarm mechanism on said base unit.

94. The method as claimed in claim 93, wherein said alarm on said personal safety device is activated as a warning alarm when said time period measured by said timer on said personal safety device expires.

95. The method as claimed in claim 94, wherein said alarm mechanism on said personal safety device comprises a further timer operable to measure the time period measured by said timer of said alarm mechanism on said base unit and said alarm on said personal safety device is activated as an incident alarm when said time period measured by said further timer on said personal safety device expires.

96. A safety system for a maritime vessel, comprising:
a base unit coupled to a control station via a communications link to enable monitoring of said vessel by said control station,
wherein said base unit is operable:
to monitor a current position of said maritime vessel with respect to a geofenced area, and
in the event that the maritime vessel exits the geofenced area, to sound an alarm, to invite entry of crew details into said base unit, and to transmit said entered crew details to the control station over said further communications link.

97. A safety system as claimed in claim 96, comprising:
a personal safety device coupled to said base unit over a local communications link, said base unit being operable, if communications between said personal safety device and said base unit over said local communications link are broken, to activate an alarm mechanism.

98. A safety system as claimed in claim 96, wherein
said base unit is responsive to a message from said control station indicating that monitoring of said vessel has been deactivated to record a current position of said vessel and store this as a port location, and to set up said geofenced area around said stored port location; and
said base unit is operable, in the event that the maritime vessel exits the geofenced area, to initiate reactivation of monitoring of said vessel by said control station.

99. A personal safety system for a maritime vessel, comprising:
personal safety means and base means coupled over a local communications link, said base means being coupled to a control station via a further communications link to enable monitoring of said vessel by said control station;
transceiver means for transmitting a periodic status message and an acknowledgement message generated in response to each received status message between said personal safety means and said base means over said local communications link; and
alert means for activating, in the event that said transceiver logic indicates that a number of either of said status and acknowledgement messages fail to be transmitted between said personal safety system and said base unit, an alarm on said personal safety means and said base means;
wherein said base means monitors a current position of said maritime vessel with respect to a geofenced area, and in the event that the maritime vessel exits the geofenced area, sounds an alarm, invites entry of crew details into said base means, and transmits said crew details to the control station over said further communications link.

100. A safety system for a maritime vessel, comprising:
base means, coupled to a control station via a communications link to enable monitoring of said vessel by said control station, for monitoring a current position of said maritime vessel with respect to a geofenced area, and in the event that the maritime vessel exits the geofenced area, for sounding an alarm, inviting entry of crew details into said base unit, and for transmitting said entered crew details to the control station over said communications link.
